(19) United States
(12) Patent Application Publication
(10) Pub. No.: US 2015/0159825 A1
(43) Pub. Date: Jun. 11, 2015

(54) Rechargeable Light Device

(71) Applicant: Michael Flynn, Rnacho Santa Fe, CA (US)

(72) Inventor: Michael Flynn, Rnacho Santa Fe, CA (US)

(21) Appl. No.: 14/098,552

(22) Filed: Dec. 6, 2013

(51) Int. Cl. F21S 9/02; F21K 99/00

(52) U.S. Cl. CPC F21S 9/02; F21K 9/135; F21Y 2101/02

(57) ABSTRACT

A rechargeable lighting device is provided comprising a threaded base configured to fit in a standard light bulb receptacle, a rechargeable battery, a logic chip, LED lights, light/motion sensor and a threaded receptacle configured to receive and power a standard light bulb. The threaded based allows the device to be screwed into an powered by a conventional light socket, and the threaded receptacle serves as a conventional light socket to provide passive power to a standard light bulb. The logic chip is programmed to run lighting routines via the LED lights and light bulb (via the threaded receptacle). Upon loss of power, motion detection by the motion sensor, the LED lights or the light bulb are powered by the rechargeable battery and activated in accordance with the logic chip's programmed lighting routine. A manual switch allows for manual control of the LED light and light bulb.

### RELATED U.S. APPLICATION DATA

This application claims priority to Provisional Application No. 61/758,780 filed Jan. 31, 2013.

### FIELD OF THE INVENTION

The present invention relates to lighting devices, particularly rechargeable lighting devices.

### BACKGROUND OF THE INVENTION

Indoor and outdoor lighting systems used in residential and other applications have become increasingly popular, particularly those that are “smart” and energy efficiency. Today, consumers must often turn on an entire set of lights with the electrical on/off switch to create night lighting. Moreover, these lights are typically dependent on connection to electrical power and not portable. It would be desirable to have a system of lights that can be selectively activated and without dependence on electrical power. The ability to power individual light bulbs provides a way for consumers to add additional lighting in appropriate settings without having to purchase and maintain a structure power supply unit, such as batteries. Such a system would be particularly useful in rural and developing areas where commercial power outlets are less common, and in emergency situations. Thus there is a need in the art for a lighting device that is versatile and can operate in the absence of active power sources such as electrical outlet connections, generators or disposable batteries.

### SUMMARY OF THE INVENTION

A rechargeable lighting device is provided comprising a threaded base configured to fit in a standard light bulb receptacle, a rechargeable battery, a logic chip, LED lights, light/motion sensor and a threaded receptacle configured to receive and power a standard light bulb. The threaded based allows the device to be screwed into an powered by a conventional light socket, and the threaded receptacle serves as a conventional light socket to provide passive power to a standard light bulb. The logic chip is programmed to run lighting routines via the LED lights and light bulb (via the threaded receptacle). Upon loss of power, motion detection, or lack of light by the sensor, the LED lights or the light bulb are powered by the rechargeable battery and activated in accordance with the logic chip's programmed lighting routine. A manual switch allows for manual control of the LED light and light bulb.

### BRIEF DESCRIPTION OF THE DRAWINGS

FIG. 1 illustrates a cross-section of a rechargeable lighting device of the present invention.

FIG. 2 illustrates a cross-section of the two-step, full installation of a rechargeable light fixture with light bulb.

FIG. 3 illustrates a bottom, transparent view of the rechargeable lighting device of the present invention.

FIG. 4 illustrates an alternate embodiment of the rechargeable lighting device of the present invention having a setting switch instead of a pull string.

FIG. 5 illustrates a block diagram depicting the communication between various elements of the lighting device.

### DETAILED DESCRIPTION

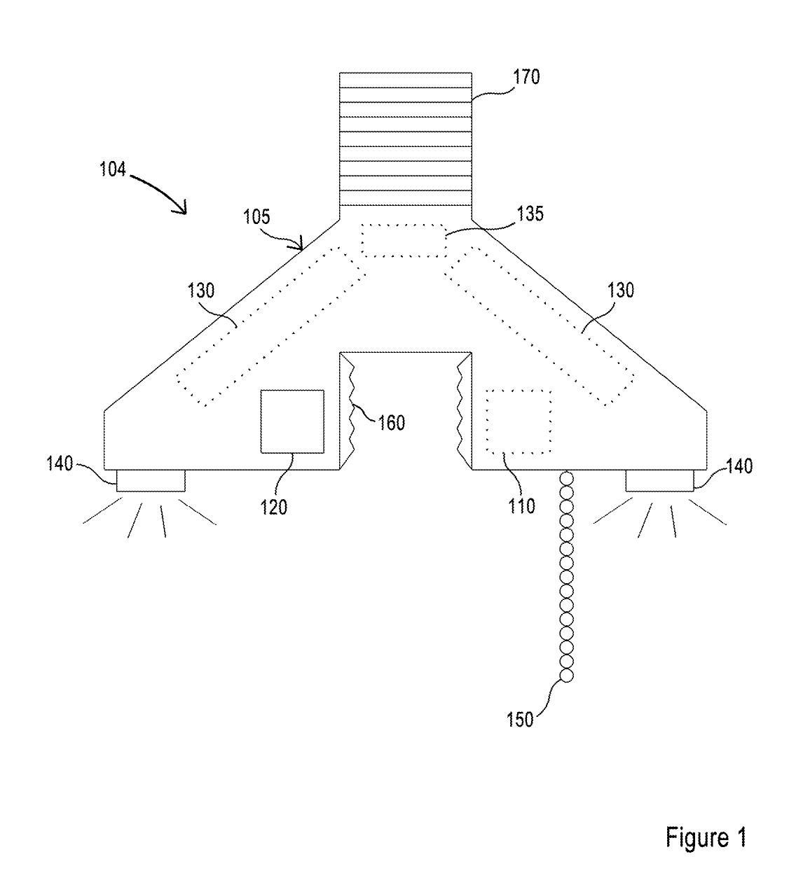

Below are described various aspects of exemplary embodiments of the rechargeable lighting device of the present invention. FIG. 1 illustrates a cross-section of the rechargeable lighting device 104 of the present invention with the plane of the cross-section running vertically through the center of the fixture. The rechargeable lighting device 104 comprises an outer shell 105 composed of a durable, hard plastic that is heat-resistant and configured to house a plurality of smaller components. Moving from the bottom to the top of the device, outer shell 105 tapers inward and terminates in a cylindrical threaded base, i.e. threaded base 170. Threaded base 170 is configured to screw the fixture into a standard light socket similar to the way a light bulb would be screwed into a light socket. Directly below the threaded base 170 (on the interior of the shell 105) lies a battery charger 135 which accepts electrical current conducted via the threaded base 170 to charge one or more rechargeable batteries 130 which are also housed within the outer shell 105. A standard method of electrical connectivity between the battery charger 105 and batteries 130 may be utilized as known in the art. The batteries 130 are charged, via charger 135, during times when the device is connected to a light socket and power is available to the device, such as when the lights are switched on at the light switch.

Below the battery charger 135 is a threaded light bulb receptacle 160 which is configured to accept a standard light bulb of desired type and wattage. Within outer shell 105, and positioned on opposing sides of threaded receptacle 160, is sensor 120 and logic control chip 110 (i.e. “logic chip” or “logic control unit”). The sensor 120 detects motion as well as light, so that the device can activate the light bulb and LED lights upon detection of motion or absence of light. In this manner, the sensor 120 can turn lights on when a person passes (for security purposes) by or when the sun goes down to keep the area illuminated. The logic control chip 110 can comprise a microchip with memory and processor functionalities. The logic control chip 110 is connected with, and is in communication with, the sensor 120, electrical receptacle 160, and threaded base 170. Battery charger 135, rechargeable battery 130 and logic chip 110 are depicted with a dashed/broken line because they are internal to the lighting device 104 and thus cannot be seen from its exterior. Conversely, sensor 120 protrudes from the device in order to allow for transmission of the infrared beam used to detect motion and to detect light (or the absence thereof). Alternatively, the sensor 120 could be place internally at the edge of the device and revealed via a clear plastic window that would allow for transmission of the infrared signal. Protruding from the opposing corners of the lower surface of the outer shell 105 are a plurality of low-powered LED lights 140. Given the advances in compact rechargeable batteries, the rechargeable battery l30 can be efficiently utilized to provide passive power to the LED lights 140 and light bulb receptacle 160. The sensor 120 is in communication with the logic control chip 110, which can be said to perform “logic control programs” or “lighting programs” upon activation. These logic control programs may be preset and programmed as known in the art. The sensor 120 detects motion/light and the logic control chip 110 can be programmed to perform a lighting program upon receiving a signal from the sensor 120.

For example, the logic control chip 110 can be programmed to activate the LED lights 140 for a set period of time (e.g. 5 minutes) upon detection of light/motion by the sensor 120. The device can activate one or more LED lights 140 depending on the level of desired lighting (and power consumption) as controlled by the logic chip 110 programming. Another program for the logic control chip 110 could activate the LED lights upon two detections of motion. Yet another program could activate the LED lights 140 to be intermittently activated for several periods, e.g. on for 5 minutes, off for 10 minutes, on for 5 minutes. Any logic control program can be implemented as desired. This functionality is ideal for providing a low-powered, portable light to provide visibility for navigating in the dark or for safety purposes to deter trespassers. The lighting device can be used as a portable light by utilizing the battery power. In that sense, assuming the rechargeable battery 130 is sufficiently charged, the light device can serve as a flashlight or portable lamp for places where power is not available or mobility is desired. As a portable light, the lighting device is more effective than a flashlight because the light is radiated in all directions rather than focused in one direction as with a flashlight. This allows an entire area to be illuminated. Similarly, when connected to a light socket, the logic control chip 110 can have programming that executes a lighting program upon loss of power due to a power outage, thus providing low-power emergency lighting. Thus, the logic control chip 110 executes lighting programs upon a signal from the sensor 120 or upon loss of power (i.e. when current ceases to pass through threaded base 170).

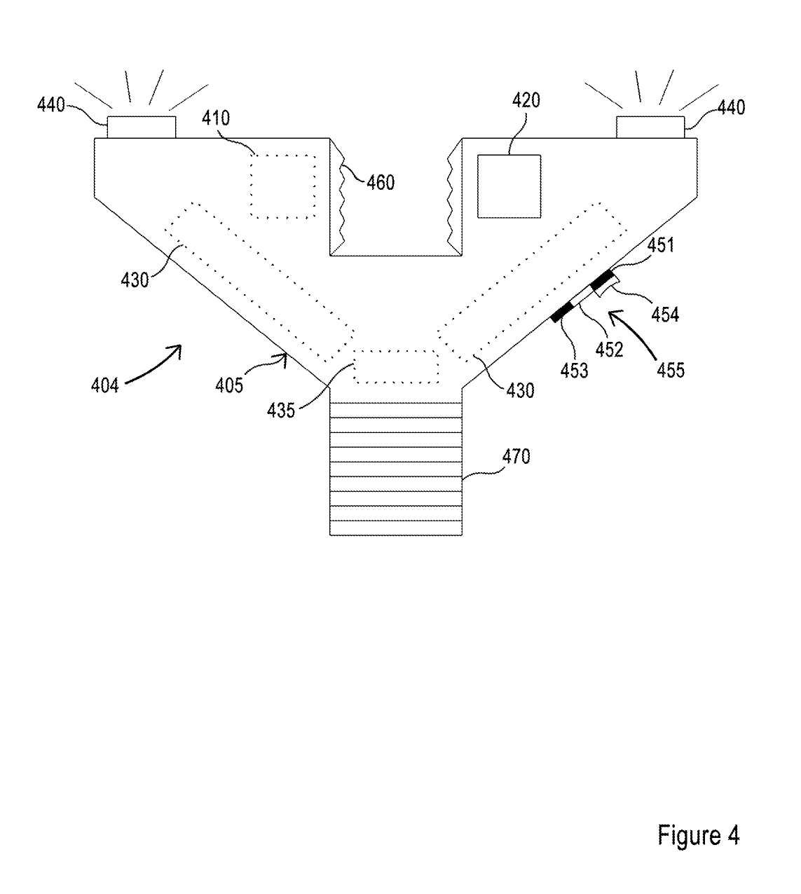

Hanging from the bottom surface of the outer shell 105 is a manual ON/OFF pull chain, i.e. switch 150 that may optionally be used to interact with the device more directly, thereby circumventing the logic control program of the logic control chip 110. By pulling the switch 150, the user can turn the LED lights on, turn the light bulb on, or turn the lighting off as desired. In an alternative embodiment, shown in FIG. 4, a three-mode switch 455 can be utilized instead of, or in addition to, a pull chain mechanism because a pull chain mechanism is only useful when the lighting device is inserted into a ceiling receptacle as opposed to scenarios where the device is sideways or inverted (e.g. in a lamp). The three mode manual switch 455 includes a button 454 with three position settings corresponding to the following settings: OFF 451, LED Light 452, and Light Bulb 453. As shown in FIG. 4, the switch is currently in the OFF position. This manual setting switch allows the user to override the logic control program to turn the device off (and override the lighting routine), turn the LED light on, or turn the light bulb on, as desired.

Thus, the lighting device 104 has a dual function in that it can be screwed into a conventional light socket (via threaded base 170), and also serve as a conventional light socket (via light bulb receptacle 160) to provide passive power to a standard light bulb. The lighting device can be advantageously utilized in homes, businesses and other settings in existing electrical lighting fixtures for providing back-up lighting when commercial utility power is interrupted in emergencies, developing countries with common power interruption and facilities that generate their electricity off-grid, such as military bases. When renewable energy is the source of power, the device can store electricity from the wind or solar sources for use at night without having to place battery backup infrastructure, such as large battery banks to provide electricity at night. An example of this would be to place these devices in one or more lighting receptacles to automatically turn on the lights via a sensor or integrate control features into the battery source to allow wireless operation when control devices are available.

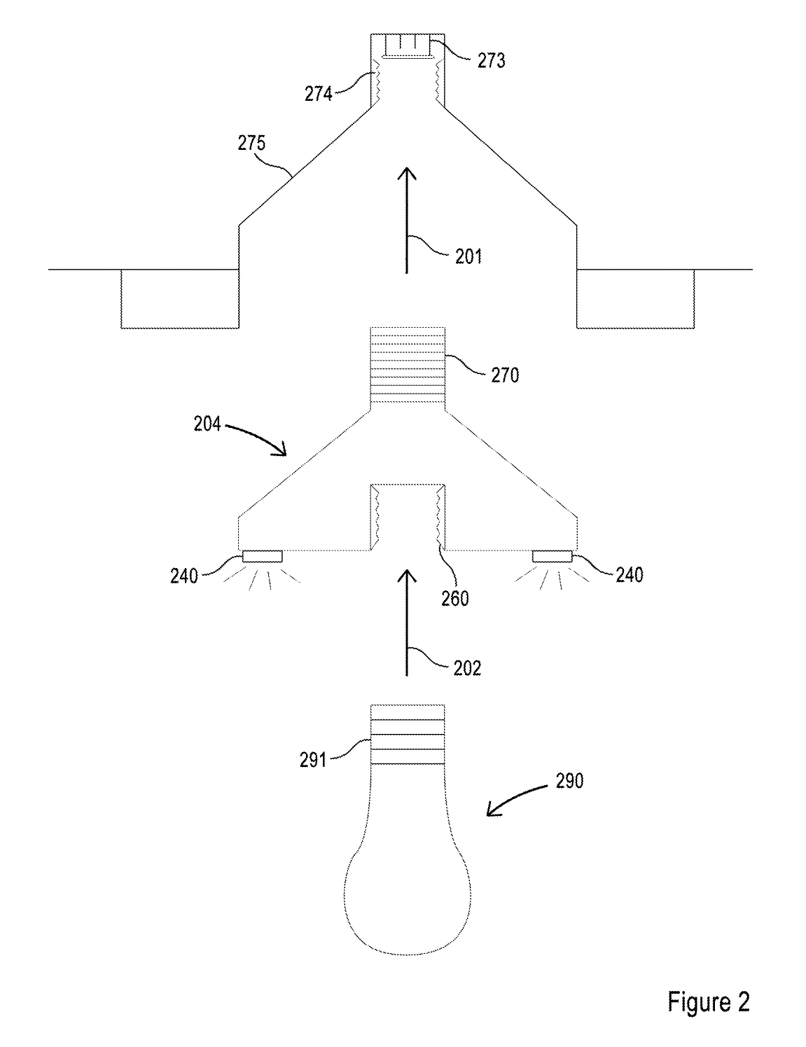

FIG. 2 illustrates a cross-section view of the assembly of the rechargeable lighting device 204 with a standard light bulb 290 and electrical receptacle 275. Motion arrow 201 indicates the insertion of the lighting device 204 into the electrical receptacle 275 where it will connect with the electrical contact 273 and power the fixture. Also shown are LED lights 240. The electrical receptacle 275 may be mounted in a ceiling, wall, or in the ground. The threaded base 270 of the lighting device 204 is screwed into the corresponding threaded section 274 of electrical receptacle 275 and is thereby held in place and in contact with electrical contact 273 as indicated by motion arrow 201. Alternatively, the threaded base 270 may have a plug mechanism instead of threading, depending on the type of electrical receptacle, wherein the lighting device 204 is plugged into the electrical receptacle instead of being screwed in. As shown by motion arrow 202, a user may install a standard light bulb 290 into the threaded receptacle 260 of lighting device 204. Motion arrow 202 indicates a light bulb's insertion via the threaded base 291 into the lighting device 204. Having connected lighting device 204 with the electrical contact of 273 of electrical receptacle 275 automatically provides a power to the battery charger which in turn charges the rechargeable battery until it is fully charged. Thus, upon disconnection from power or loss of power, the battery is charged and is able to power the LED lights or light bulb 290 (which is connected to threaded receptacle 260 via its threaded base 291. As such, the lighting device acts as a portable light for emergency situations, which can be triggered automatically by the logic chip's detection of power loss, by the sensor's detection of motion (or absence of light), or by using the manual switch (element 150 in FIG. 1 and element 455 in FIG. 4).

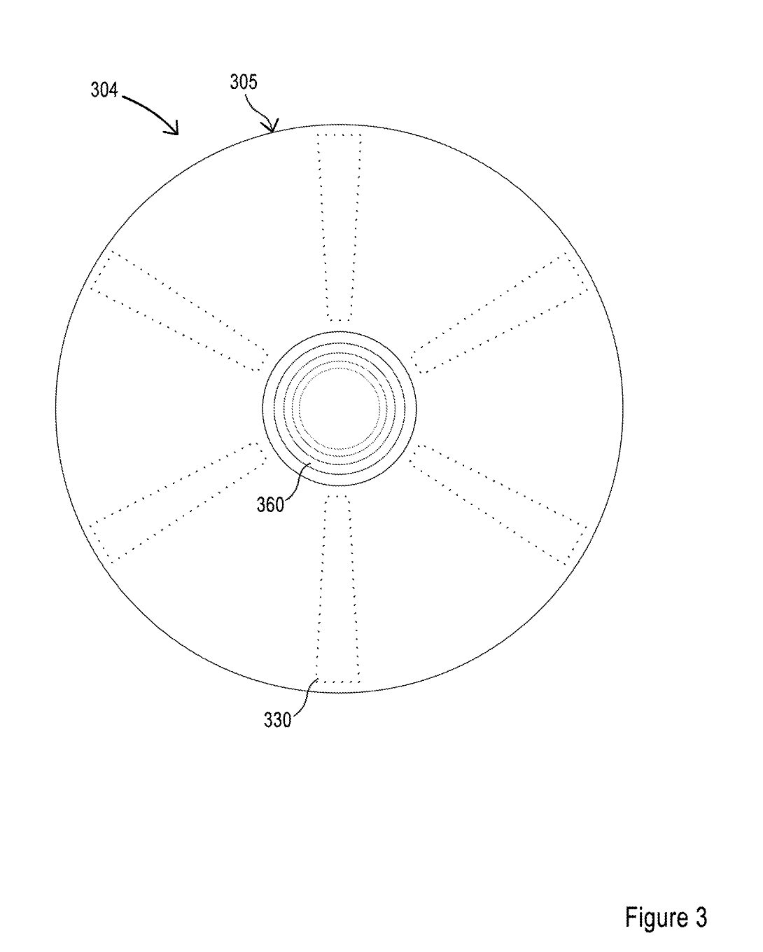

FIG. 3 illustrates a bottom view of the rechargeable lighting device 305, showing the outer shell 305, threaded receptacle 360, and plurality of batteries 360 (which are internal to the lighting device and thus shown with dashed lines). FIG. 3 shows an exemplary configuration of the batteries 360 within the lighting device 304. As discussed above, the batteries 330 power the rechargeable lighting device 304 in the event of complete power loss to a house, building, or other structure in which the device is being utilized. However, there are other scenarios in which backup power is beneficial, such as in locations where a power outlet is not available or where one does not want to utilize power from an outlet. Alternatively, the user may want to initiate a night-light mode using the batteries and low-power LED lights.

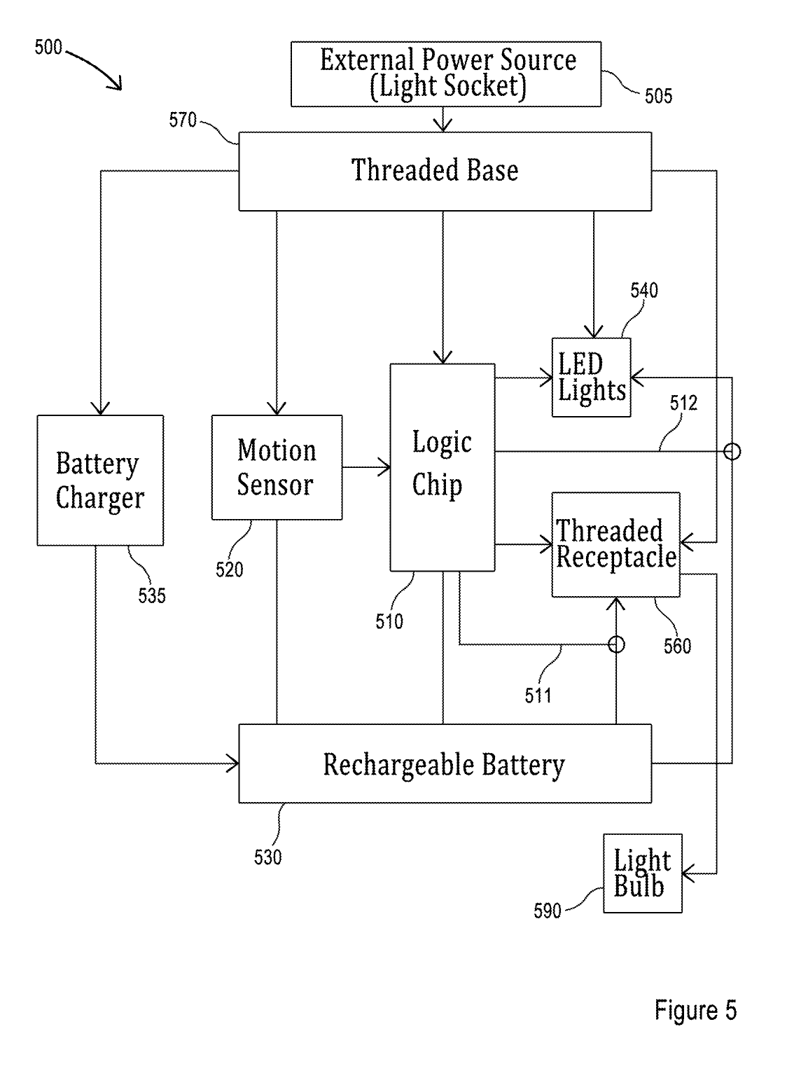

FIG. 5 illustrates a block diagram 500 that provides a conceptual representation of the electrical interactions or connections between various elements of the lighting device. The external power source 505 (i.e. light socket/receptacle) provides electricity to the threaded based 570 of the lighting device. The external power source 505 is electrically connected with the battery charger 535, sensor 520, logic chip 510, LED lights 540 and threaded receptacle 560. As described above, sensor 520 can detect motion as well as light and provide a signal to logic chip 510 when motion, or the absence of light (darkness) it detected. Similarly, the rechargeable battery 530 is also electrically connected the battery charger 535, sensor 520, logic chip 510, LED lights 540 and threaded receptacle 560. When the device is screwed into an external power source (light socket/receptacle) then these elements 510-560 are powered via the threaded insert, whereas during power outages or portable use these elements 510-560 are powered via the rechargeable battery 530. The battery charger 535 is electrically connected to, and powers, the batteries 530. The logic chip 510 determines whether and when the LED lights 540 or threaded receptacle 560 (and thus the light bulb 590) is powered or not. The logic chip 510 receives input from the sensor 520 as well as the threaded base 570. For example, the logic chip 510 can be programmed to activate the LED lights 540 upon loss of power from the threaded based 570 or, alternatively, upon detection of motion or absence of light by sensor 520. Similarly, the logic chip 510 can be programmed to activate the light bulb 590 (via the threaded receptacle 560) upon loss of power from the threaded based 570 or, alternatively, upon detection of motion by the sensor 520. Pathways 511 and 512 contain electrical switches as known in the art to carry out these alternative lighting options.

While there have been described herein what are considered to be preferred and exemplary embodiments of the present invention, other modifications of the invention shall be apparent to those skilled in the art from the teachings herein. For example, the relative dimensions of the device may be altered while keeping within the spirit and teachings of the invention. It is therefore desired to be secured, in the appended claims all such modifications as fall within the spirit and scope of the invention.

What is claimed is:

1. A rechargeable lighting device comprising:
a rechargeable battery that includes a battery charger;
a sensor capable of detecting motion and/or light;
an LED light;
a threaded base configured to connect with an standard light socket, wherein the standard light socket provides power to the battery charger which in turn charges the rechargeable battery;
a threaded receptacle configured to receive a standard light bulb, wherein the light bulb can be powered by said rechargeable battery or via a standard light socket; and
a logic chip, said logic chip being in communication with, and controlling, the LED light and the light bulb receptacle, the logic chip being also in communication with the sensor.

2. The rechargeable lighting device of claim 1, wherein upon loss of power from the standard light socket, the logic chip is programmed to turn the LED light on using power from the rechargeable battery.

3. The rechargeable lighting device of claim 1, wherein upon loss of power from the standard light socket, the logic chip is programmed to turn the standard light bulb on via the threaded receptacle, using power from the rechargeable battery.

4. The rechargeable lighting device of claim 1, wherein upon detection of motion or absence of light by the sensor, the logic chip is programmed to turn the LED light on using power from the rechargeable battery.

5. The rechargeable lighting device of claim 1, wherein upon detection of motion or absence of light by the sensor, the logic chip is programmed to turn the standard light bulb on via the threaded receptacle, using power from the rechargeable battery.

6. The rechargeable lighting device of claim 1, wherein the device contains additional LED lights that can be selectively activated by the sensor and logic chip.

7. A rechargeable lighting device, comprising:
a rechargeable battery that includes a battery charger;
a sensor capable of detecting, motion and/or light;
an LED light;
a threaded base configured to connect with an standard light socket;
a threaded base configured to connect with an standard light socket, wherein the standard light socket provides power to the battery charger which in turn charges the rechargeable battery;
a logic chip, said logic chip being in communication with, and controlling, the LED light and the light bulb receptacle, the logic chip being also in communication with the sensor; and
a manual switch with three settings for turning the device off, turning the LED light on, and turning the light bulb on.

8. The rechargeable lighting device of claim 7, wherein upon loss of power from the standard light socket, the logic chip is programmed to turn the LED light on using power from the rechargeable battery.

9. chargeable lighting device of claim 7, wherein upon loss of power from the standard light socket, the logic chip is programmed to turn the standard light bulb on via the threaded receptacle, using power from the rechargeable battery.

10. The rechargeable lighting device of claim 7, wherein upon detection of motion or absence of light by the sensor, the logic chip is programmed to turn the LED light on using power from the rechargeable battery.

11. rechargeable lighting device of claim 7, wherein upon detection of motion or absence of light by the sensor, the logic chip is programmed to turn the standard light bulb on via the threaded receptacle, using power from the rechargeable battery.

12. The rechargeable lighting device of claim 7, wherein the device contains additional LED lights that can be selectively activated by the sensor and logic chip.
